(19) United States
(12) Patent Application Publication
(10) Pub. No.: US 2012/0139165 A1
(43) Pub. Date: Jun. 7, 2012

(54) METHOD AND SYSTEM FOR PRODUCING A WIND TURBINE ROTOR BLADE

(76) Inventor: Uli RAMM, Osnabruck (DE)

(21) Appl. No.: 13/233,075

(22) Filed: Sep. 15, 2011

(51) Int. Cl. B29C 35/02; B29C 35/08; B29C 70/00; B29C 67/00

(52) U.S. Cl. 264/492; 264/320; 264/405; 264/241; 249/117

(57) ABSTRACT

A method for utilizing an infusion mesh for producing a curved rotor blade for a wind turbine rotor is provided. The method includes providing an infusion mesh including a polymer; placing the mesh into a curved mold and arranging the mesh to have the curved shape of the mold, and applying thermal energy to at least parts of the infusion mesh, so that at least parts of the mesh are heated to a melting temperature of the polymer material.

### BACKGROUND OF THE INVENTION

The subject matter described herein relates generally to methods and systems for the production of rotor blades, and more particularly, to methods and systems for producing curved rotor blades for wind turbines.

At least some known wind turbines include a tower and a nacelle mounted on the tower. A rotor is rotatably mounted to the nacelle and is coupled to a generator by a shaft. A plurality of blades extend from the rotor. The blades are oriented such that wind passing over the blades turns the rotor and rotates the shaft, thereby driving the generator to generate electricity.

While conventional rotor blades have a straight body, extending from the root portion at the hub to the tip portion in a straight line, there is a tendency to build curved rotor blades due to their improved aerodynamic properties.

At the same time, rotor blades having a body of layers of carbon fiber and a resin have been developed. Carbon fiber is generally less permeable to resin than conventional glass fiber. Rotor blades are typically produced by laminating two halves, one representing the suction side of the rotor blade, and one representing the pressure side. Each half is produced as a single item, and the halves are subsequently mounted together, for example by using an adhesive. Two molds, each having an inverse shape of the respective half of the rotor blade, are used in the process.

The fiber material is stacked into the mold, and a foil is put on top of the stack. Subsequently, a vacuum is applied to the space between the mold and the foil including the fiber layers, such that a resin is sucked into the space and filling up the hollow portions in the fibrous material. Prefabricated parts like the spar cap, root ring, etc are produced separately and applied in the mold with the rotor blade half. The blade halves will be infused together with the prefabricated parts. The shell parts will be moved out of the mold if bonded together and the blade is closed.

During the infusion of prefabricated parts, like the spar cap or the root ring, it has shown that it is demanding to have the resin flow homogeneously into all gaps of the stacked fiber material. Hence, a mesh is placed underneath the stack of the construction in order to promote the flow of the resin to all regions of the fiber stack.

However, with the curved rotor blades described above, the mesh has to be bent in order to follow the curved shape of the mold. In the bending process, the mesh, which is typically relatively inflexible, may tend to build up waves or wrinkles. These are undesirable, as they may later influence the shape of the produced rotor blade half. In order to remedy this, one might use a flexible mesh, which might help reducing undulations and waves. However, in this case, the weight of the construction would press the flexible mesh together, and the flow of the resin through the mesh might be obstructed, which is also undesirable.

Hence, there is a desire to have a method or system which uses a mesh in the production of a wind turbine rotor blade, which avoids the aforementioned disadvantages.

### BRIEF DESCRIPTION OF THE INVENTION

In one aspect, a method for utilizing an infusion mesh for producing a curved rotor blade for a wind turbine rotor is provided. The method includes providing an infusion mesh including a polymer; placing the mesh into a curved mold and arranging the mesh to have the curved shape of the mold; and applying thermal energy to at least parts of the infusion mesh, so that at least parts of the mesh are heated to a melting temperature of the polymer material.

In another aspect, a method for producing a curved rotor blade for a wind turbine rotor is provided. The method includes providing a mold having a curved shape; providing an infusion mesh comprising a polymer; placing the mesh into the mold such that the mesh fits the curved mold; applying thermal energy to the infusion mesh, so that at least parts of the mesh are heated to a melting temperature of the polymer material, wherein the mesh adapts to the inner contour of the mold; providing the components of the rotor blade and placing them into the mold; and, infusing a resin into the mold.

In yet another aspect, an apparatus for producing a curved wind turbine rotor blade is provided. The apparatus includes a mold body having an inverse shape of a rotor blade half; and, a polymer mesh arranged to have the shape of the mold body; wherein the mesh has at least locally been treated with thermal energy after being arranged in the mold body.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a schematic top view of a mold for a wind turbine rotor blade.

FIG. 4 is a schematic cross sectional view of a mold of a wind turbine rotor blade.

FIG. 5 is a schematic cross sectional view of a stacked rotor blade assembly.

FIG. 6 shows an infusion mesh before and after an arranging process according to embodiments.

FIG. 7 shows a treatment of an infusion mesh according to embodiments.

FIG. 8 shows an infusion mesh after a treatment according to embodiments.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a wind turbine system that can be produced easier and more precisely. More specifically, they include a method of treating an infusion mesh used in the production of curved rotor blades. In addition, they include a mold for a rotor blade with improved properties.

As used herein, the term mesh is intended to be representative of a semi-permeable barrier made of connected strands of exible/ductile material. More specifically, mesh is intended to include a polymer material, and to have regularly arranged passages through the material. As used herein, the term “melting temperature” is intended to be representative of a temperature at which a polymer material becomes soft. Typically, polymer materials have no defined melting point such as, e.g., metals, but a temperature range in which the polymer becomes increasingly soft when the temperature rises within the borders of the range. Hence, the term “melting temperature” of a polymer material is intended to be representative of any temperature within that range. As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

Embodiments described herein pertain to a mold for a curved rotor blade, in the following also “swept rotor blade”. In the production process of a wind turbine rotor blade, layers of fiber are stacked into a mold body having the inverse shape of one half of the blade. On top of the stack, a foil is placed such that the assembly of the mold, stacked material and foil is vacuum tight. Subsequently, a vacuum is applied to the inner space between the mold and the foil, which leads to a resin being sucked into the stack through an infusion channel. The resin typically flows in from the bottom area of the mold and then flows upwards into the stacked material, filling up the gaps in the stack and the fibrous material with resin, which subsequently cures and thus hardens. This method is both applied for producing rotor blade halves, as well as certain parts of a rotor blade such as a shear web, a spar cap or a root ring.

Between the mold body, which is below the stack, and the stacked material, there is provided a mesh. The mesh provides for better flow of the resin to all areas of the stack. For producing swept rotor blades, mold bodies having a curved shape (equivalent to the rotor blade) are used. The mesh, typically having a rectangular shape when coming from a supplier, thus needs to be adapted or bent to the curved shape of the mold (or of a supporting heating table) in order to cover all areas between the mold and the stack. In this process, the relatively inflexible mesh tends to build up buckles, waves, or undulations. This typically happens on the inner side during the bending process.

In order to minimize the unwanted undulations, according to embodiments the mesh is treated with thermal energy after being arranged in the mold body. When a certain temperature is reached, which is specific for the material used, typically a polymer, the mesh becomes flexible. Due to gravity or an applied force, the undesired waves, undulations, etc, will thus vanish, respectively be equalized.

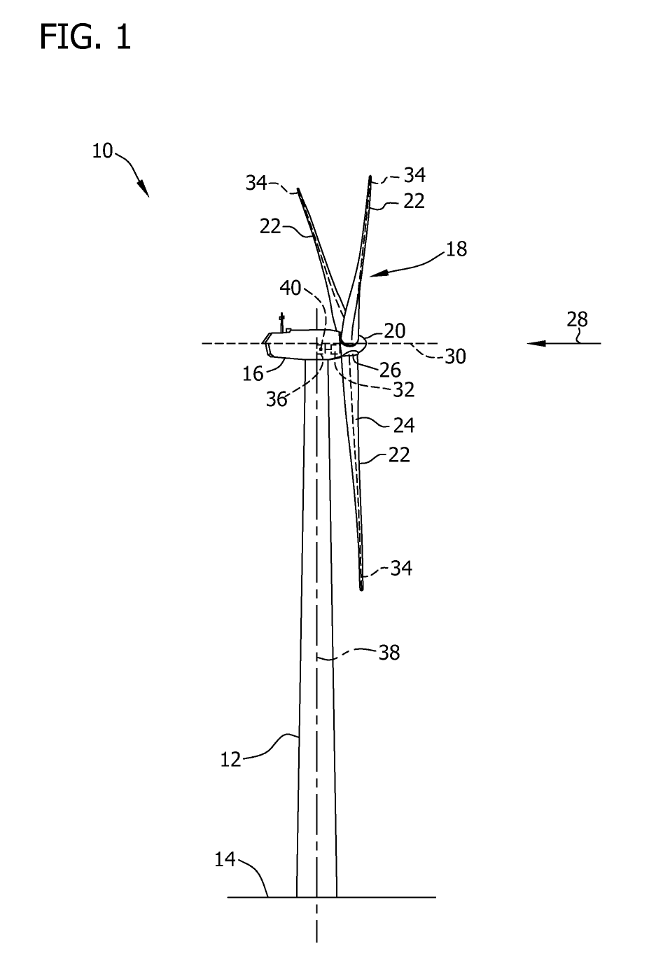

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

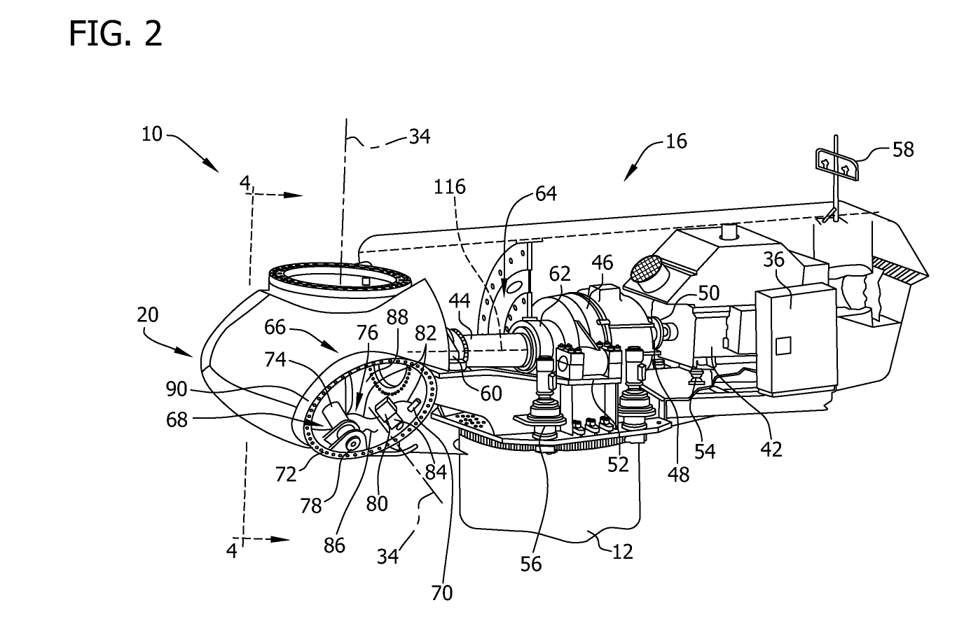

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

A power generator 84 is coupled to sensor 70, overspeed control system 80, and pitch drive system 68 to provide a source of power to pitch assembly 66. In the exemplary embodiment, power generator 84 provides a continuing source of power to pitch assembly 66 during operation of wind turbine 10. In an alternative embodiment, power generator 84 provides power to pitch assembly 66 during an electrical power loss event of wind turbine 10. The electrical power loss event may include power grid loss, malfunctioning of the turbine electrical system, and/or failure of the wind turbine control system 36. During the electrical power loss event, power generator 84 operates to provide electrical power to pitch assembly 66 such that pitch assembly 66 can operate during the electrical power loss event.

In the exemplary embodiment, pitch drive system 68, sensor 70, overspeed control system 80, cables 82, and power generator 84 are each positioned in a cavity 86 defined by an inner surface 88 of hub 20. In a particular embodiment, pitch drive system 68, sensor 70, overspeed control system 80, cables 82, and/or power generator 84 are coupled, directly or indirectly, to inner surface 88. In an alternative embodiment, pitch drive system 68, sensor 70, overspeed control system 80, cables 82, and power generator 84 are positioned with respect to an outer surface 90 of hub 20 and may be coupled, directly or indirectly, to outer surface 90.

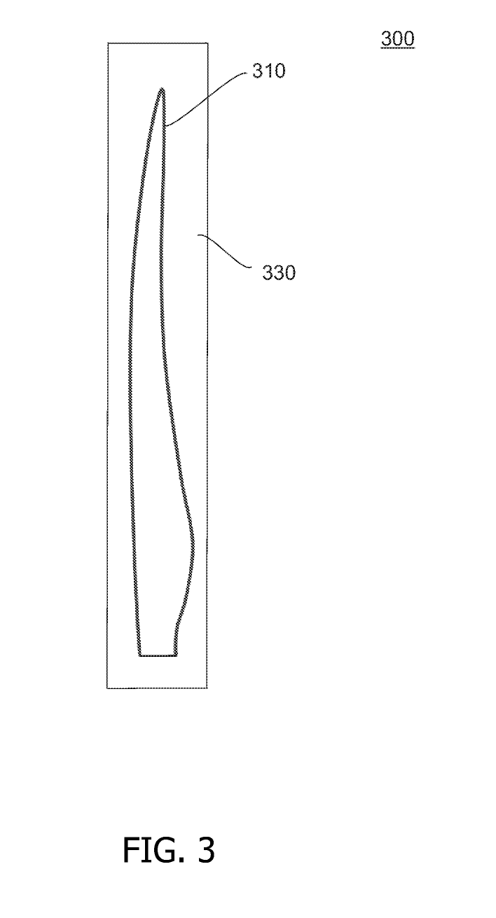

FIG. 3 shows a curved mold 300 for producing a swept wind turbine rotor blade. It includes a support 320 and a mold body 310 having the shape of a rotor blade to be produced.

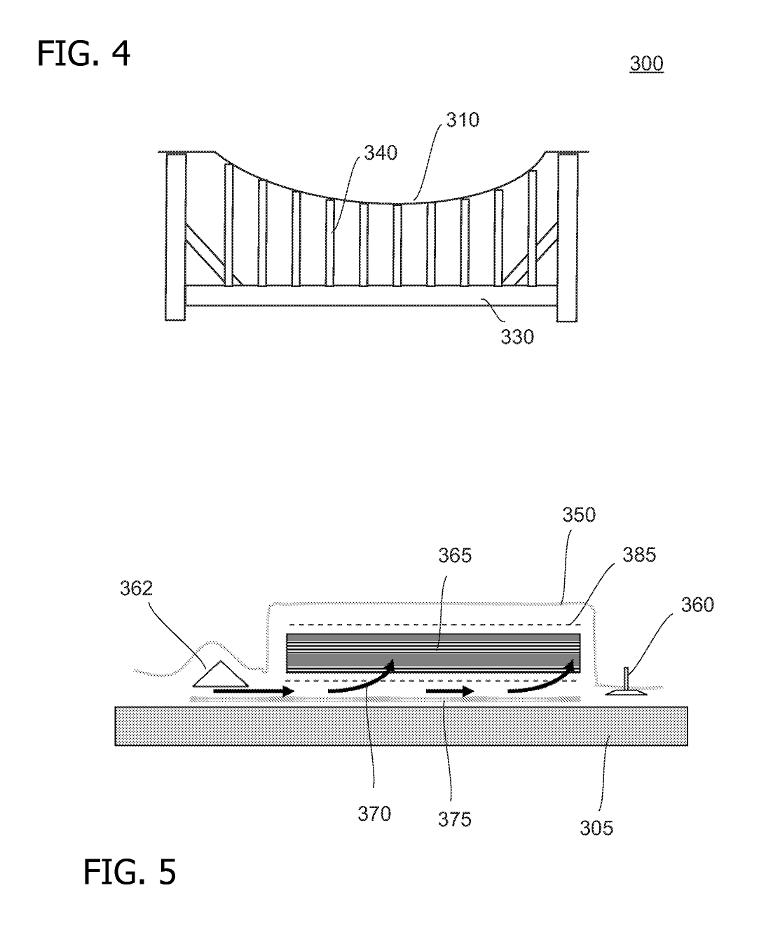

FIG. 4 shows a schematical cross sectional view through a middle section of the mold of FIG. 3. A support frame construction 330 has several individual supports 340 supporting the mold body 310.

FIG. 5 shows a schematic cross sectional view of an infusion apparatus for the production of a rotor blade part, e.g. a sparcap, according to embodiments. On a heatable table 305, an infusion mesh 375 is provided. Thereon, a release foil 385 is provided, on which the stacked fibrous material 365 for the construction is placed. The construction may for example include layers of carbon fiber. Typically, the stack includes 30 to 80 stacked material layers, more typically 45 to 65 layers. The release foil facilitates the loosening of the produced rotor blade part from the infusion mesh 375 after curing of the resin. Another release foil 385 is provided on top of the stacked material 365. On top of the stacked material 365, the vacuum foil 350 is provided and sealed on the edges. Vacuum is then applied and the resin is sucked through the construction, respectively stack 365. A further foil, which may be applied between the infusion mesh and the release foil, is not shown here.

To this end, a vacuum port 360 is used for applying a vacuum to the space enclosed between the vacuum foil 350 and the heatable table 305, the table being in embodiments a mold body 310 as in FIGS. 3 and 4.

Due to the application of the vacuum, resin 370 (indicated by arrows) is sucked in via infusion channel 362 into the stacked material 365, respectively the construction.

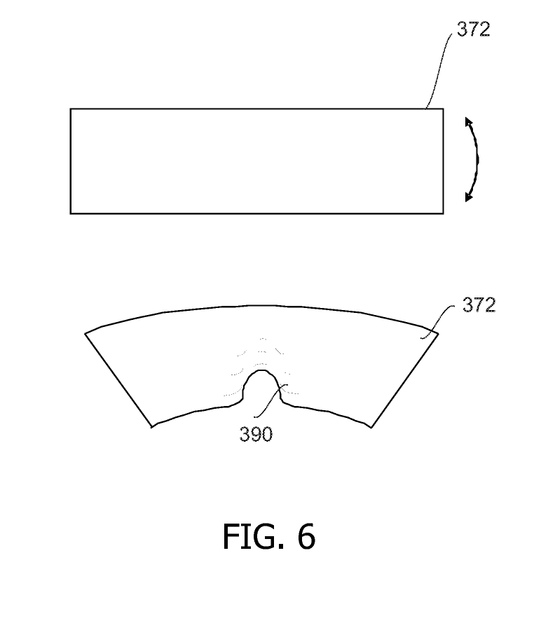

FIG. 6 shows, that if an infusion mesh 372 (top) is bent, according to embodiments, in order to have the shape of a mold for a curved rotor blade part (swept blade), the rearranged mesh 372 (below) has waves, buckles, and/or undulations 390 on the side having the smaller radius (inner side). To keep the mesh 372 in its bent state, clamps 410 may be applied in embodiments. The outer side, having the greater radius, is at the same time typically mechanically stretched, which is not shown. Such a bent mesh has disadvantages when it is used in an infusion process as shown in FIG. 5.

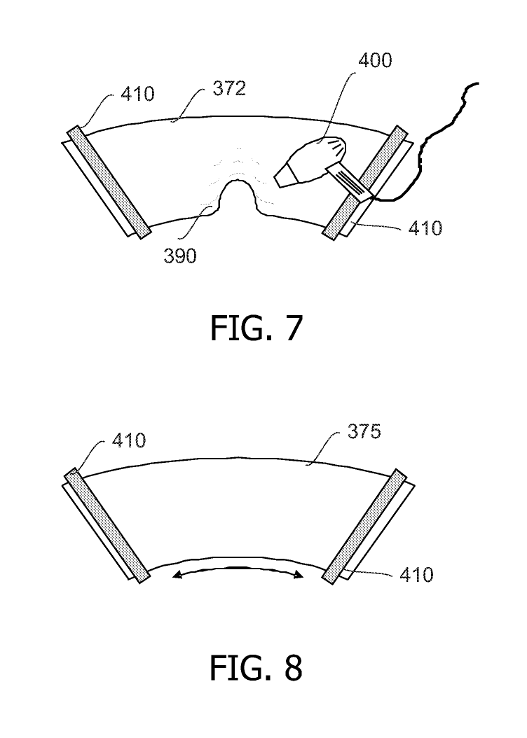

FIG. 7 shows that the bent mesh 372, as described above, is treated by the local application of thermal energy, according to embodiments, in order to smoothen the surface of the mesh 372. To this end, any suitable heat source or heating device 400 may be applied. This may be used to apply infrared radiation, hot air, or the hot gas stream of a blow torch or the like. For instance, an infrared lamp may be used, or a blow torch, or an electric fan heater. This serves to smoothen the surface of the bent mesh 372, respectively it leads to a vanishing of the waves/undulations 390 with the result of an even surface of the mesh 375 shown in FIG. 8.

After the melting temperature Tₘ of the mesh material has been reached locally by using the heating device 400, the inventors have observed that undulations and buckles in the infusion mesh 372 vanish and the formerly uneven parts of the mesh become even, hence the undulations are smoothened. The mechanism of this process is believed to be as follows. The molecules of the polymer are oriented after original fabrication of the mesh. During heating, the molecular structure of the mesh 372 is locally altered, which results in a shrinking process. Differently said, the molecules are re-orientated by heating the mesh up higher than Tₘ. This means, that the mesh tends to shrink during heating, and will shrink in the loose area including the undulations/waves. Another cause for the perceived effect might be caused by the influence of gravity, as the softened material will, above Tₘ, follow the gravitational force and move downwards until it reaches the supporting structure, typically the heating table 305 or the mold body 310, which also leads to the vanishing of undulations.

In embodiments, the vanishing or removal of undulations by heating may be further promoted by locally applying a force on the undulated areas by a tool subsequently to the heating, for example by using a metal plate.

A resulting mesh 375 after the treatment described above is shown in FIG. 8. This mesh 375 can subsequently be used in an infusion process as described with respect to FIG. 5, producing a curved wind turbine rotor blade or curved part of a wind turbine rotor blade, such as a shear web.

Thus, in embodiments, a method for treating an infusion mesh 372 for producing a curved rotor blade for a wind turbine rotor includes to provide the infusion mesh 372 including a polymer; to place the mesh into the curved mold 310, or on a heating table 305, and to arrange the mesh to have the curved shape of the mold or table. Subsequently, thermal energy is applied to at least parts of the infusion mesh 372, so that at least parts of the mesh are heated to a melting temperature Tₘ of the polymer material.

In embodiments, the mesh may include (as non-limiting examples) polymers like high density polyethylene (HDPE), low density polyethylene (LDPE), Polyethylene (PE), and Polypropylene (PP), but also other polymers are possible, provided that they are suitable for the smoothing process as described herein, which can be tested by simple experimentation.

In typical embodiments, the mesh has between 0.5 and 2 openings per mm, more typically between 0.8 and 1.5 openings per mm, for example 1.0 openings per mm or 1.2 openings per mm. The typical thickness of the mesh is between 0.5 mm and 2 mm, more typically between 0.8 and 1.4 mm, such as 1.0 mm or 1.1 mm.

The above-described systems and methods facilitate an improved method for producing curved rotor blade parts or curved rotor blades. More specifically, they provide an improved method for treating an infusion mesh for the production process of curved rotor blade parts and bodies.

Exemplary embodiments of systems and methods for producing a wind turbine rotor blade are described above in detail. The systems and methods are not limited to the specific embodiments described herein, but rather, components of the systems and/or steps of the methods may be utilized independently and separately from other components and/or steps described herein. For example, they may be used in conjunction with other types of curved blades like rotor blades for aircrafts, and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for utilizing an infusion mesh for producing a curved rotor blade for a wind turbine rotor, comprising:
a) providing an infusion mesh including a polymer;
b) placing the mesh into a curved mold and arranging the mesh to have the curved shape of the mold; and
c) applying thermal energy to at least parts of the infusion mesh, so that at least parts of the mesh are heated to a melting temperature of the polymer material.

2. The method of claim 1, wherein applying thermal energy comprises applying infrared radiation, applying heated air, or applying reaction products of a combustion process.

3. The method of claim 1, wherein applying thermal energy comprises using a lamp, an electric heater, or a blow torch.

4. The method of claim 1, wherein arranging the mesh to have the curved shape of the mold comprises that the mesh develops buckles and/or undulations.

5. The method of claim 1, wherein after the melting temperature of the mesh has been reached, undulations and buckles in the infusion mesh vanish.

6. The method of claim 5, wherein the undulations vanish due to the influence of gravity.

7. The method of claim 5, wherein the undulations vanish due to a shrinking process in the mesh material.

8. The method of claim 1, wherein thermal energy is applied to the mesh area including the buckles and/or undulations.

9. The method of claim 1, wherein the mesh is fixed via clamps after the arrangement.

10. The method of claim 1, wherein the mesh comprises at least one element from the list consisting of HDPE, LDPE, PE, and PP.

11. The method of claim 1, wherein the mesh has between 0.5 and 2 openings per mm.

12. The method of claim 1, wherein the mesh has a thickness between 0.5 mm and 2 mm.

13. A method for producing a curved rotor blade for a wind turbine rotor, comprising:
a) providing a mold having a curved shape;
b) providing an infusion mesh comprising a polymer;
c) placing the mesh into the mold such that the mesh fits the curved mold;
d) applying thermal energy to the infusion mesh, so that at least parts of the mesh are heated to a melting temperature of the polymer material, wherein the mesh adapts to the inner contour of the mold;
e) providing the components of the rotor blade and placing them into the mold; and,
f) infusing a resin into the mold.

14. The method of claim 13, wherein during adaption of the mesh to the contour of the mold, buckles and/or undulations in the mesh vanish.

15. The method of claim 13, wherein thermal energy is applied to sections of the mesh exhibiting buckles and/or undulations.

16. An apparatus for producing a curved wind turbine rotor blade, comprising.
a mold body having an inverse shape of a rotor blade half; and,
a polymer mesh arranged to have the shape of the mold body;
wherein the mesh has at least locally been treated with thermal energy after being arranged in the mold body.

17. The curved mold of claim 16, wherein a melting temperature of the mesh material has been reached at least locally during the treatment with thermal energy.

18. The curved mold of claim 16, wherein the mesh comprises at least one element from the list consisting of HDPE, LDPE, PE, and PP.

19. The curved mold of claim 16, wherein the mesh has between 0.5 and 2 openings per mm.

20. The curved mold of claim 16, wherein the mesh has a thickness between 0.5 mm and 2 mm.
